(19) United States
(12) Patent Application Publication
(10) Pub. No.: US 2011/0051299 A1
(43) Pub. Date: Mar. 3, 2011

(54) SEMICONDUCTOR INTEGRATED CIRCUIT

(75) Inventor: Takayuki Hiraoka, Kanagawa (JP)

(73) Assignee: KABUSHIKI KAISHA TOSHIBA, Tokyo (JP)

(21) Appl. No.: 12/754,746

(22) Filed: Apr. 6, 2010

(30) Foreign Application Priority Data
Sep. 1, 2009 (JP) 2009-201257

(51) Int. Cl. H02H 9/00

(52) U.S. Cl. 361/56

(57) ABSTRACT

A semiconductor integrated circuit includes: an internal circuit formed on a semiconductor chip, power being supplied thereto via a first power supply wire and a second power supply wire; input and output pads that exchange an input signal or an output signal with the internal circuit; input and output cells including first electrostatic protection elements that protect the internal circuit from electrostatic discharge between the input and output pads and the first or second power supply wire; and second power supply protection elements provided adjacent to the input and output cells and including diode strings connected between the first power supply wire and the second power supply wire.

### CROSS-REFERENCE TO RELATED APPLICATIONS

This application is based upon and claims the benefit of priority from the prior Japanese Patent Application No. 2009-201257, filed on Sep. 1, 2009; the entire contents of which are incorporated herein by reference.

### BACKGROUND OF THE INVENTION

1. Field of the Invention

The present invention relates to a semiconductor integrated circuit, and, more particularly is suitably applied to a method of improving electrostatic discharge immunity of the semiconductor integrated circuit.

2. Description of the Related Art

In a semiconductor integrated circuit, to protect an internal circuit formed on a semiconductor chip, in some case, an electrostatic protection circuit is provided on the same semiconductor chip.

For example, Patent Document 1 “Mong-Dou Ker and Kun-Hsien Lin ‘ESD Protection Design for I/O Cells With Embedded SCR Structure as Power-Rail ESD Clamp Device in Nanoscale CMOS Technology’ IEEE JOURNAL OF SOLID-STATE CIRCUITS, VOL. 40, NO. 11, NOVEMBER 2005” discloses a method of providing silicon controlled rectifiers (SCRs) connected between power supply wires in input cells and output cells and, when electrostatic discharge is detected between the power supply wires, turning on the SCRs to thereby protect an internal circuit from electrostatic discharge damage.

Patent Document 2 “James W. Miller, Melanie Etherton, Michael G. Khazhinsky, Michael Stockinger, and James C. Weldon ‘Comprehensive ESD Protection for Flip-Chip Products in a Dual Gate Oxide 65 nm CMOS Technology’ EOS/ESD SYMPOSIUM 06-186 4A.4-1 TO 4A.4-10” discloses a method of providing field effect transistors connected between power supply wires in I/O cells and, when electrostatic discharge is detected between the power supply wires, turning on the field effect transistors to thereby protect an internal circuit from electrostatic discharge damage.

However, in the methods disclosed in Patent Documents 1 and 2, the SCRs or the field effect transistors are used to protect the internal circuit from electrostatic discharge damage. Therefore, a trigger circuit is necessary and, moreover, a device area is increased to improve a discharge ability.

In the method disclosed in Patent Document 1, because the SCRs are used, responsiveness to a high-speed surge is poor. In the method disclosed in Patent Document 2, because the field effect transistors are used, uniform operation performance is poor.

### BRIEF SUMMARY OF THE INVENTION

A semiconductor integrated circuit according to an embodiment of the present invention comprises: a first power supply pad arranged in a peripheral section of a semiconductor chip; a second power supply pad arranged in the peripheral section of the semiconductor chip; a first power supply wire connected to the first power supply pad; a second power supply wire connected to the second power supply pad; an internal circuit formed on the semiconductor chip, power being supplied thereto via the first power supply wire and the second power supply wire; input and output pads that exchange an input signal or an output signal with the internal circuit; input and output cells including first electrostatic protection elements that protect the internal circuit from electrostatic discharge between the input and output pads and the first or second power supply wire; and second power supply protection elements provided adjacent to the input and output cells and including diode strings connected between the first power supply wire and the second power supply wire.

A semiconductor integrated circuit according to an embodiment of the present invention comprises: a first power supply pad arranged in a peripheral section of a semiconductor chip; a second power supply pad arranged in the peripheral section of the semiconductor chip; a first power supply wire connected to the first power supply pad; a second power supply wire connected to the second power supply pad; an internal circuit formed on the semiconductor chip, power being supplied thereto via the first power supply wire and the second power supply wire; input and output pads that exchange an input signal or an output signal with the internal circuit; input and output cells including first electrostatic protection elements that protect the internal circuit from electrostatic discharge between the input and output pads and the first or second power supply wire; and second power supply protection elements provided in the input and output cells to be arranged between the first power supply wire and the second power supply wire and including diode strings connected between the first power supply wire and the second power supply wire.

A semiconductor integrated circuit according to an embodiment of the present invention comprises: a first power supply pad arranged in a peripheral section of a semiconductor chip; a second power supply pad arranged in the peripheral section of the semiconductor chip; a first power supply wire connected to the first power supply pad; a second power supply wire connected to the second power supply pad; an internal circuit formed on the semiconductor chip, power being supplied thereto via the first power supply wire and the second power supply wire; first and second input and output pads that exchange an input signal or an output signal with the internal circuit; a first diode string connected between the first power supply wire and the second power supply wire such that a forward direction of the connection is a direction from a high potential side to a low potential side, the first diode string forming a discharge path for a surge current input to the first input and output pad; and a second diode string connected between the first power supply wire and the second power supply wire such that a forward direction of the connection is a direction from a high potential side to a low potential side, the second diode string forming a discharge path for a surge current input to the second input and output pad.

### BRIEF DESCRIPTION OF THE DRAWINGS

FIG. 1 is a plan view of the schematic configuration of a semiconductor integrated circuit according to a first embodiment of the present invention;

FIG. 2 is an enlarged plan view of an A section shown in FIG. 1;

FIG. 3 is a diagram of an equivalent circuit of the A section shown in FIG. 2;

FIG. 4 is a diagram of an equivalent circuit of each of power supply protection elements including diode strings S2 to S6 provided among input and output cells shown in FIG. 3;

FIG. 5 is a plan view of a layout configuration of the power supply protection elements including the diode strings shown in FIG. 4;

FIG. 6 is a plan view of the schematic configuration of a peripheral section of a semiconductor integrated circuit according to a second embodiment of the present invention;

FIG. 7 is a plan view of the schematic configuration of a peripheral section of a semiconductor integrated circuit according to a third embodiment of the present invention; and

FIG. 8 is a plan view of a layout configuration of power supply protection elements shown in FIG. 7.

### DETAILED DESCRIPTION OF THE INVENTION

Exemplary embodiments of the present invention are explained in detail below with reference to the accompanying drawings. The present invention is not limited by the embodiments.

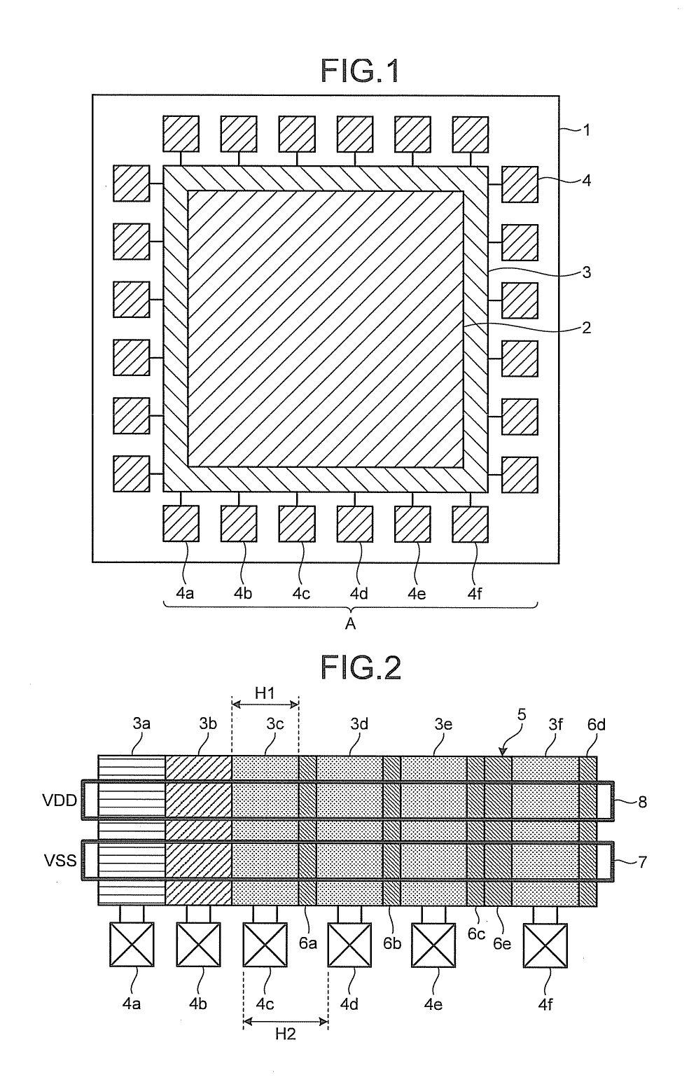

FIG. 1 is a plan view of the schematic configuration of a semiconductor integrated circuit according to a first embodiment of the present invention.

In FIG. 1, an internal circuit 2 is formed on a semiconductor chip 1. As the internal circuit 2, for example, a signal processing circuit such as a logic circuit, a processor, a memory, an image sensor, or an ASIC can be formed.

Pad electrodes 4 are arranged in a peripheral section of the semiconductor chip 1. A peripheral circuit 3 is arranged between the pad electrodes 4 and the internal circuit 2. As the pad electrodes 4, power supply pads 4a and 4b and input and output pads 4c to 4f can be provided. The power supply pad 4a can deliver a low-potential power supply VSS. The power supply pad 4b can deliver a high-potential power supply VDD. The input and output pads 4c to 4f can exchange signals input or output between the input and output pads 4c to 4f and the internal circuit 2.

FIG. 2 is an enlarged plan view of an A section shown in FIG. 1.

In FIG. 2, on the peripheral circuit 3, power supply cells 3a and 3b and input and output cells 3c to 3f are respectively arranged to correspond to the power supply pads 4a and 4b and the input and output pads 4c to 4f. In the power supply cells 3a and 3b, power supply protection elements that protect the internal circuit 2 from electrostatic discharge between power supply wires 7 and 8 can be provided. In the input and output cells 3c to 3f, electrostatic protection elements that protect the internal circuit 2 from electrostatic discharge between the input and output pads 4c to 4f and the power supply wires 7 and 8 can be provided. In the input and output cells 3c to 3f, input buffers that input signals, which are applied to the input and output pads 4c to 4f, to the internal circuit 2, output buffers that output a signal, which is output from the internal circuit 2, to the outside via the input and output pads 4c to 4f, level shifters that shift signals, which are input to and output from the internal circuit 2, to a predetermined level, or the like can also be provided. For example, in the output cell 3c, an inverter can be used as the input buffer. In the output cell 3c, a first field effect transistor and a second field effect transistor can be used as the output buffer. The first field effect transistor is connected between the power supply wire 7 and the input and output pad 4c. A gate potential of the first field effect transistor is controlled by a signal output from the internal circuit 2. The second field effect transistor is connected between the power supply wire 8 and the input and output pad 4c. A gate potential of the second field effect transistor is controlled by a signal output from the internal circuit 2.

A spacer cell 5 is arranged in a space between the input and output cells 3e and 3f. Power supply protection elements 6a to 6c are respectively arranged in spaces among the input and output cells 3c to 3f. Power supply protection element 6d is arranged in a space outside output cell 3f. A power supply protection element 6e is arranged on the spacer cell 5. The power supply wires 7 and 8 are drawn around in the peripheral section of the semiconductor chip 1 to cross the power supply cells 3a and 3b, the input and output cells 3c to 3f, and the power supply protection elements 6a to 6e.

The power supply pad 4a is connected to the power supply wire 7 and the power supply pad 4b is connected to the power supply wire 8. The power supply cells 3a and 3b and the power supply protection elements 6a to 6e are connected between the power supply wires 7 and 8. The input and output pads 4c to 4f are connected to the internal circuit 2 respectively via the input and output cells 3c to 3f. Power supply protection elements 6a to 6e can include diode strings connected between the power supply wires 7 and 8. An array pitch H2 of the input and output pads 4c to 4e is desirably set larger than cell width H1 of the input and output cells 3c to 3e to make it possible to insert the power supply protection elements 6a to 6b among the output cells 3c to 3f.

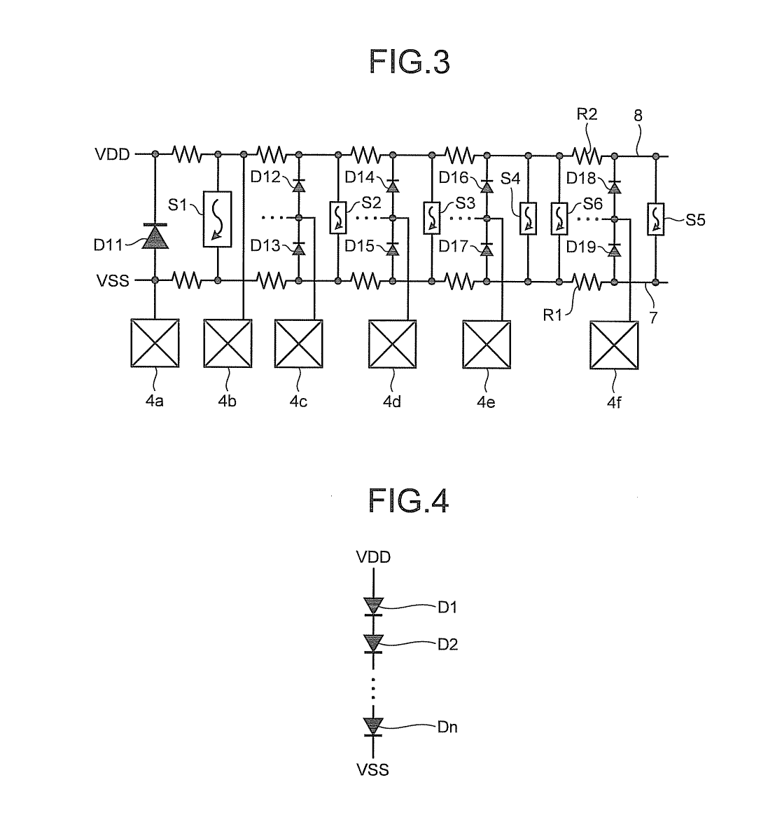

FIG. 3 is a diagram of an equivalent circuit of the A section shown in FIG. 2. FIG. 4 is a diagram of an equivalent circuit of a diode string.

In FIG. 3, a diode D11 is provided in the power supply cell 3a shown in FIG. 2. A diode string S1 is provided as a power supply protection element in the power supply cell 3b shown in FIG. 2. Diodes D12 and D13 are provided in the input and output cell 3c. Diodes D14 and D15 are provided in the input and output cell 3d. Diodes D16 and D17 are provided in the input and output cell 3e. Diodes D18 and D19 are provided in the input and output cell 3f. Diode strings S2 to S6 are respectively used as the power supply protection elements 6a to 6e. As shown in FIG. 4, each of the diode strings S2 to S6 can be configured by connecting n (n is an integer equal to or larger than 2) diodes D1 to Dn in series. Parasitic resistor R1 and R2 are present in the power supply wires 7 and 8.

The power supply protection element of the power supply cell 3b does not always have to be the diode string S1. A device other than the diode string S1 such as a MOS transistor, a bipolar junction transistor (BJT), or an SCR can also be used.

The diode D11 is connected between the power supply wires 7 and 8 such that a forward direction of the connection is a direction from a low potential side to a high potential side. The diodes D12, D14, D16, and D18 are connected between the respective input and output pads 4c to 4f and the power supply wire 8 such that a forward direction of the connection is a direction from a low potential side to a high potential side. The diodes D13, D15, D17, and D19 are connected between the respective input and output pads 4c to 4f and the power supply wire 7 such that a forward direction of the connection is a direction from a low potential side to a high potential side. The diode strings S1 to S6 are connected between the power supply wires 7 and 8 such that a forward direction of the connection is a direction from a high potential side to a low potential side. The number n of the diodes D1 to Dn of each of the diode strings S1 to S6 is desirably set to be within a specification of standby leak between the power supply wires 7 and 8.

When a surge voltage is applied to the power supply pads 4a and 4b, the diode D11 of the power supply cell 3a or the diode string S1 of the power supply cell 3b and the diode strings S2 to S6 provided among the input and output cells 3c to 3f function via the parasitic resistors R1 and R2 according to the polarity of the surge and perform electrostatic discharge (ESD) protection. In this case, a high protection ability can be expected compared with a protection ability obtained when the diode string S1 alone of the power supply cell 3b absorbs a surge between power supplies.

Protection of the internal circuit 2 is performed in several ways as explained below when a surge voltage is applied to the input and output pads 4c to 4f and flows to the power supply pads 4a and 4b. The input and output pad 4f present in a position most distant from the power supply pads 4a and 4b among the input and output pads 4c to 4f is explained as an example.

When a surge having negative polarity is input to the input and output pad 4f with the power supply pad 4a set as a reference pad, the diode D19 performs clamp operation and protects the internal circuit 2. Because a discharge ability of the diode D19 is high, the influence of the parasitic resistors R1 and R2 can be generally neglected.

When a surge having positive polarity is input to the input and output pad 4f with the power supply pad 4b set as a reference pad, the diode D18 performs clamp operation and protects the internal circuit 2. Because a discharge ability of the diode D18 is high, the influence of the parasitic resistors R1 and R2 can be generally neglected.

When a surge having positive polarity is input to the input and output pad 4f with the power supply pad 4a set as a reference pad, the diode strings S1 to S6 connected to the power supply wires 7 and 8 via the diode D18 perform clamp operation and protect the internal circuit 2. In this case, compared with protection performed by only the diode string S1 mounted on the power supply cell 3b, when the diode strings S2 to S6 are mounted among the input and output cells 3c to 3f, the diode strings S1 to S6 can easily cooperatively operate during discharge, the influence of the parasitic resistors R1 and R2 can be reduced. Even the input and output pad 4f present most distant from the power supply pad 4a can perform sufficient ESD protection.

When a surge having negative polarity is input to the input and output pad 4f with the power supply pad 4b set as a reference pad, the diode strings S1 to S6 connected to the power supply wires 7 and 8 via the diode D19 perform clamp operation and protect the internal circuit 2. In this case, compared with protection performed by only the diode string S1 mounted on the power supply cell 3b, when the diode strings S2 to S6 are mounted among the input and output cells 3c to 3f, the diode strings S1 to S6 can easily cooperatively operate during discharge, the influence of the parasitic resistors R1 and R2 can be reduced. Even the input and output pad 4f present most distant from the power supply pad 4b can perform sufficient ESD protection.

The diode strings S2 to S6 are respectively used as the power supply protection elements 6a to 6e. This makes it unnecessary to provide a trigger circuit and makes it possible to improve a discharge ability and suppress an increase in a device area. Compared with responsiveness to a high-speed surge obtained when SCRs are used as the power supply protection elements 6a to 6e, it is possible to improve the responsiveness, improve uniform operation performance, and cause the power supply protection elements 6a to 6e to stably operate in parallel.

The power supply protection elements 6a to 6c are respectively arranged in the spaces among the input and output cells 3c to 3f. This makes it possible to reduce, even when a large surge current flows to the power supply wires 7 and 8, the length of a discharge path for the surge current and suppress a voltage rise due to the parasitic resistors R1 and R2 of the power supply wires 7 and 8. Therefore, it is possible to stably protect the internal circuit 2 from electrostatic discharge damage.

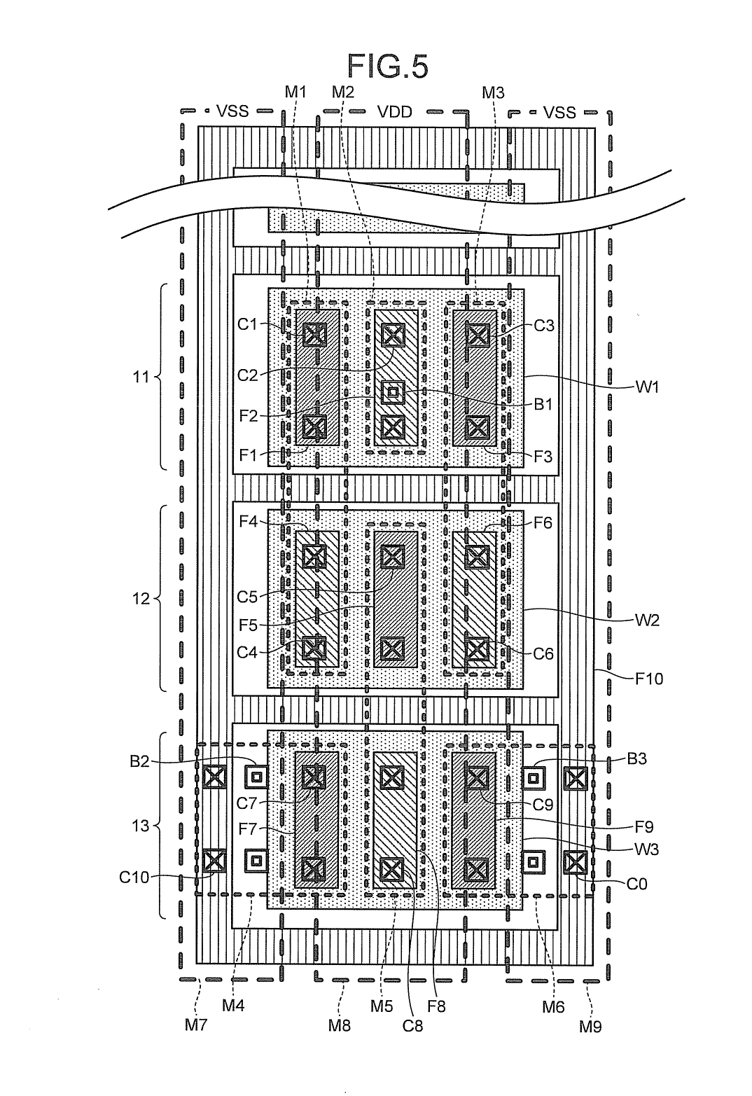

FIG. 5 is a plan view of a layout configuration of the power supply protection elements shown in FIG. 2.

In FIG. 5, diodes 11 to 13 connected in series are provided in the diode strings S2 to S6 shown in FIG. 3. N wells W1 to W3 surrounded by a P-type high-concentration diffusion layer F10 are respectively provided in the diodes 11 to 13. The P-type high-concentration diffusion layer F10 can configure a guard ring.

In the N well W1, an N-type high-concentration diffusion layer F1, a P-type high-concentration diffusion layer F2, and an N-type high-concentration diffusion layer F3 are arranged side by side in a wiring direction of the power supply wires 7 and 8. In the N well W2, a P-type high-concentration diffusion layer F4, an N-type high-concentration diffusion layer F5, and a P-type high-concentration diffusion layer F6 are arranged side by side in the wiring direction of the power supply wires 7 and 8. In the N well W3, an N-type high-concentration diffusion layer F7, a P-type high-concentration diffusion layer F8, and an N-type high-concentration diffusion layer F9 are arranged side by side in the wiring direction of the power supply wires 7 and 8. The N-type high-concentration diffusion layer F1, the P-type high-concentration diffusion layer F4, and the N-type high-concentration diffusion layer F7 are desirably arranged on one straight line. The P-type high-concentration diffusion layer F2, the N-type high-concentration diffusion layer F5, and the P-type high-concentration diffusion layer F8 are desirably arranged on one straight line. The N-type high-concentration diffusion layer F3, the P-type high-concentration diffusion layer F6, and the N-type high-concentration diffusion layer F9 are desirably arranged on one straight line.

Wiring layers M1 to M6 are formed on the N wells W1 to W3. The wiring layer M1 is connected to the N-type high-concentration diffusion layer F1 via contacts C1 and connected to the P-type high-concentration diffusion layer F4 via contacts C4. The wiring layer M2 is connected to the P-type high-concentration diffusion layer F2 via contacts C2. The wiring layer M3 is connected to the N-type high-concentration diffusion layer F3 via contacts C3 and connected to the P-type high-concentration diffusion layer F6 via contacts C6. The wiring layer M4 is connected to the N-type high-concentration diffusion layer F7 via contacts C7 and connected to the P-type high-concentration diffusion layer F10 via contacts C10. The wring layer M5 is connected to the N-type high-concentration diffusion layer F5 via contacts C5 and connected to the P-type high-concentration diffusion layer F8 via contacts C8. The wiring layer M6 is connected to the N-type high-concentration diffusion layer F9 via contacts C9 and connected to the P-type high-concentration diffusion layer F10 via contacts C0.

Wiring layers M7 to M9 are formed on the wiring layers M1 to M6. The wiring layer M7 is connected to the wiring layer M4 via vias 32 and connected to the power supply wire 7. The wiring layer M8 is connected to the wiring layer M2 via vias B1 and connected to the power supply wire 8. The wiring layer M9 is connected to the wiring layer M6 via vias B3 and connected to the power supply wire 7.

In the embodiment shown in FIG. 5, a configuration in which the diodes 11 to 13 are connected in series in three stages is explained as an example. However, to increase the number of stages of diodes connected in series, the diodes 11 to 13 shown in FIG. 5 only have to be repeatedly arranged in a direction orthogonal to the power supply wires 7 and 8. Therefore, it is possible to increase the number of stages of the diodes connected in series without increasing the width of the power supply protection elements 6a to 6d shown in FIG. 2. Even when the spaces among the input and output cells 3c to 3f are narrow, it is possible to respectively arrange the power supply protection elements 6a to 6d in the spaces among the input and output cells 3c to 3f.

The wiring layers M7 to M9 can be formed on a wiring layer different from a wiring layer on which the power supply wires 7 and 8 shown in FIG. 2 are formed. However, the wiring layers M7 to M9 can also be formed on a wiring layer same as the wiring layer on which the power supply wires 7 and 8 shown in FIG. 2 are formed.

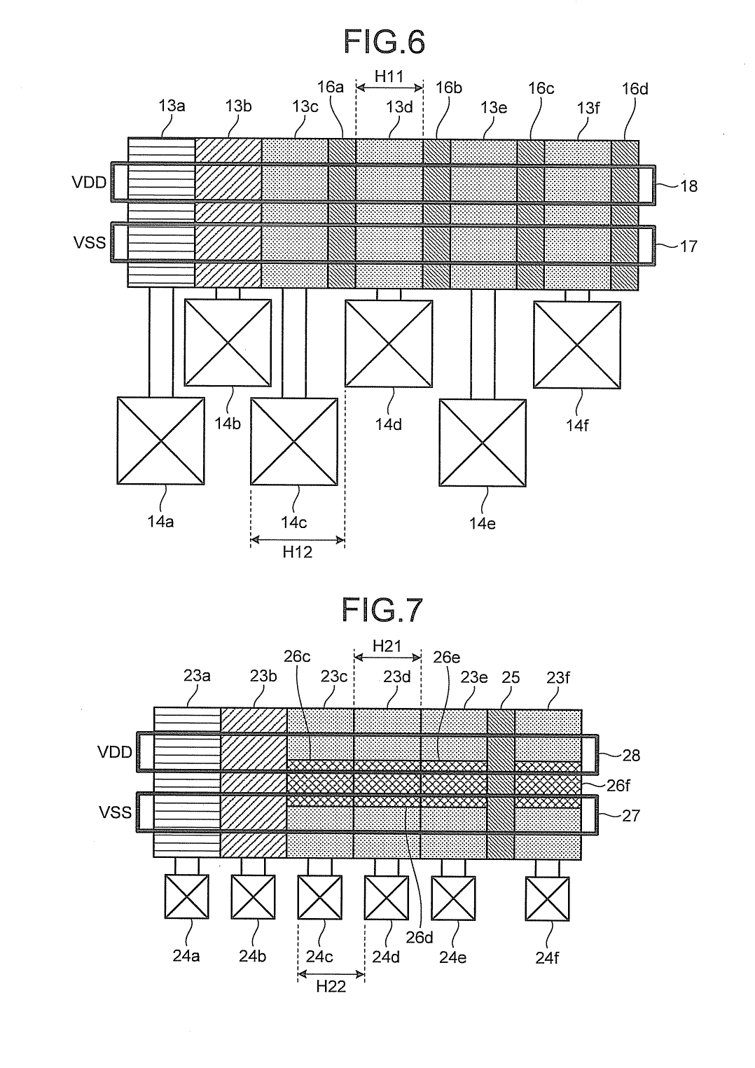

FIG. 6 is a plan view of the schematic configuration of a peripheral section of a semiconductor integrated circuit according to a second embodiment of the present invention.

In FIG. 6, pad electrodes are arranged in zigzag in a peripheral section of a semiconductor chip. As the pad electrodes, power supply pads 14a and 14b and input and output pads 14c to 14f are provided. Power supply cells 13a and 13b and input and output cells 13c to 13f are respectively arranged to correspond to the power supply pads 14a and 14b and the input and output pads 14c to 14f. Power supply protection elements 16a to 16c are respectively arranged in spaces among the input and output cells 13c to 13f. Power supply wires 17 and 18 are drawn around in the peripheral section of the semiconductor chip to cross the power supply cells 13a and 13b, the input and output cells 13c to 13f, and the power supply protection elements 16a to 16d.

The power supply pad 14a is connected to the power supply wire 17. The power supply pad 14b is connected to the power supply wire 18. The power supply cells 13a and 13b and the power supply protection elements 16a to 16d are connected between the power supply wires 17 and 18. The input and output pads 14c to 14f are connected to an internal circuit respectively via the input and output cells 13c to 13f. The power supply protection elements 16a to 16d can include diode strings connected between the power supply wires 17 and 18. An array pitch H12 of the input and output pads 14c to 14f is desirably set larger than cell width H11 of the input and output cells 13c to 13f to make it possible to insert the power supply protection elements 16a to 16c among the input and output cells 13c to 13f. The diode D11 shown in FIG. 3 can be provided in the power supply cell 13a. In the power supply cell 13b, the diode string S1 shown in FIG. 3 can also be provided or a device other than the diode string S1 such as a MOS transistor, a BJT, or a SCR can also be provided.

The power supply protection elements 16a to 16c are respectively arranged in the spaces among the input and output cells 13c to 13f. This makes it possible to stably protect the internal circuit from electrostatic discharge damage while suppressing an increase in a device area even when the pad electrodes are arranged in zigzag.

FIG. 7 is a plan view of the schematic configuration of a peripheral section of a semiconductor integrated circuit according to a third embodiment of the present invention.

In FIG. 7, pad electrodes are arranged in a peripheral section of a semiconductor chip. As the pad electrodes, power supply pads 24a and 24b and input and output pads 24c to 24f are provided. Power supply cells 23a and 23b and input and output cells 23c to 23f are respectively arranged to correspond to the power supply pads 24a and 24b and the input and output pads 24c to 24f. A spacer cell 25 is arranged in a space between the input and output cells 23e and 23f. Power supply protection elements 26c to 26f are respectively provided in the input and output cells 23c to 23f. Power supply wires 27 and 28 are drawn around in the peripheral section of the semiconductor chip to cross the power supply cells 23a and 23b and the input and output cells 23c to 23f. The power supply protection elements 26c to 26f can be respectively provided in the input and output cells 23c to 23f to be arranged between the power supply wires 27 and 28. The power supply protection elements 26c to 26f can also be arranged to overlap the power supply wires 27 and 28.

The power supply pad 24a is connected to the power supply wire 27. The power supply pad 24b is connected to the power supply wire 28. The power supply cells 23a and 23b and the power supply protection elements 26a to 26f are connected between the power supply wires 27 and 28. The input and output pads 24c to 24f are connected to an internal circuit respectively via the input and output cells 23c to 23f. The power supply protection elements 26c to 26f can include diode strings connected between the power supply wires 27 and 28. An array pitch H21 of the input and output pads 24c to 24e is desirably set to correspond to cell width H22 of the input and output cells 23c to 23d. The diode D11 shown in FIG. 3 can be provided in the power supply cell 23a. In the power supply cell 23b, the diode string S1 shown in FIG. 3 can be also be provide or a device other than the diode string S1 such as a MOS transistor, a BJT, or a SCR can also be provided.

The power supply protection elements 26c to 26f are arranged between the power supply wires 27 and 28. This makes it unnecessary to provide a space between the input and output cells 23e and 23f and makes it possible to stably protect the internal circuit from electrostatic discharge damage while suppressing an increase in a device area.

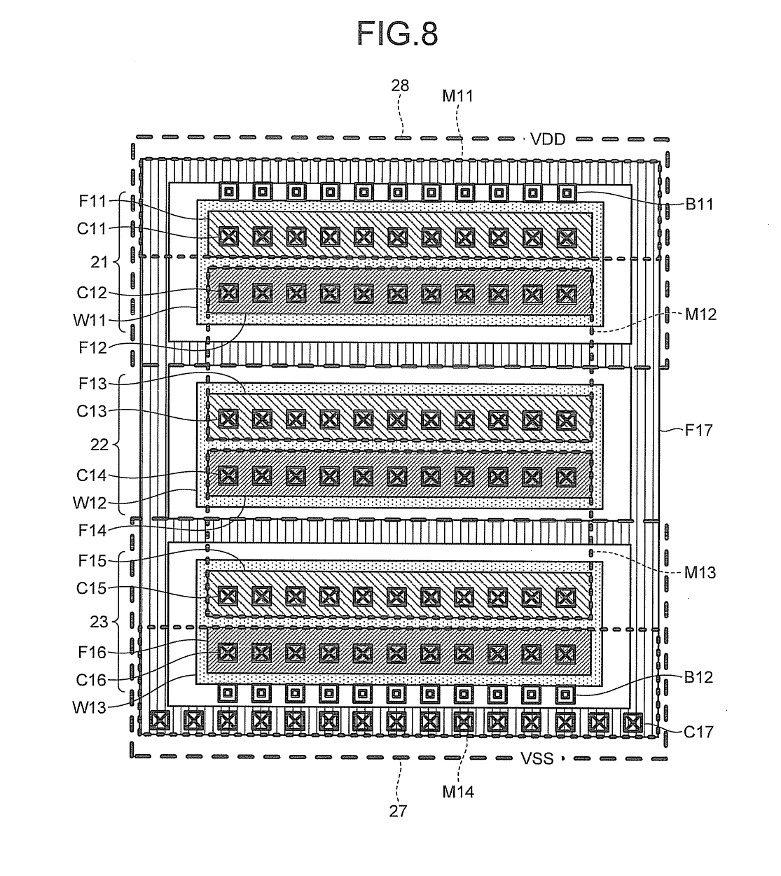

FIG. 8 is a plan view of a layout configuration of the power supply protection elements shown in FIG. 7.

In FIG. 8, the diode strings included in the power supply protection elements 26c to 26f shown in FIG. 7 include diodes 21 to 23 connected in series. N wells W11 to W13 surrounded by a P-type high-concentration diffusion layer F17 are respectively provided in the diodes 21 to 23. The P-type high-concentration diffusion layer F17 can configure a guard ring.

In the N well W11, a P-type high-concentration diffusion layer F11 and an N-type high-concentration diffusion layer F12 are arranged side by side in a direction orthogonal to the power supply wires 27 and 28. In the N well W12, a P-type high-concentration diffusion layer F13 and an N-type high-concentration diffusion layer F14 are arranged side by side in the direction orthogonal to the power supply wires 27 and 28. In the N well W13, a P-type high-concentration diffusion layer F15 and an N-type high-concentration diffusion layer F16 are arranged side by side in the direction orthogonal to the power supply wires 27 and 28.

Wiring layers M11 to M14 are formed on the N wells W11 to W13. The wiring layer M11 is connected to the P-type high-concentration diffusion layer F11 via contacts C11. The wiring layer M12 is connected to the N-type high-concentration diffusion layer F12 via contacts C12 and connected to the P-type high-concentration diffusion layer F13 via contacts C13. The wiring layer M13 is connected to the N-type high-concentration diffusion layer F14 via contacts C14 and connected to the P-type high-concentration diffusion layer F15 via contacts C15. The wiring layer M14 is connected to the N-type high-concentration diffusion layer F16 via contacts C16 and connected to the P-type high-concentration diffusion layer F17 via contacts C17.

The power supply wires 27 and 28 are formed on the wiring layers N11 to M14. The power supply wire 27 is connected to the wiring layer M14 via vias B12. The power supply wire 28 is connected to the wiring layer N11 via vias B11.

In the embodiment shown in FIG. 8, a configuration in which the diodes 21 to 23 are connected in series in three stages is explained as an example. However, to increase the number of stages of diodes connected in series, the diodes 21 to 23 only have to be repeatedly arranged in a direction orthogonal to the power supply wires 27 and 28.

In the embodiment explained above, a method of arranging the input and output cells not to overlap the input and output pads is explained. However, the present invention can also be applied to a structure in which the input and output cells are arranged under the input and output pads.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor integrated circuit comprising:
a first power supply pad arranged in a peripheral section of a semiconductor chip;
a second power supply pad arranged in the peripheral section of the semiconductor chip;
a first power supply wire connected to the first power supply pad;
a second power supply wire connected to the second power supply pad;
an internal circuit formed on the semiconductor chip, power being supplied thereto via the first power supply wire and the second power supply wire;
input and output pads that exchange an input signal or an output signal with the internal circuit;
input and output cells including first electrostatic protection elements that protect the internal circuit from electrostatic discharge between the input and output pads and the first or second power supply wire; and
second power supply protection elements provided adjacent to the input and output cells and including diode strings connected between the first power supply wire and the second power supply wire.

2. The semiconductor integrated circuit according to claim 1, wherein an array pitch of the input and output pads is set to correspond to an array pitch of the input and output cells and the second power supply protection elements.

3. The semiconductor integrated circuit according to claim 1, wherein the diode strings are connected such that a forward direction of the connection is a direction from a high potential side to a low potential side in the first and second power supply wires.

4. The semiconductor integrated circuit according to claim 1, wherein a number of diodes of each of the diode strings is set to be within a specification of standby leak between the first power supply wire and the second power supply wire.

5. The semiconductor integrated circuit according to claim 1, wherein the diode strings are respectively provided for the input and output cells.

6. The semiconductor integrated circuit according to claim 1, wherein the diode strings are respectively provided for the input and output pads.

7. The semiconductor integrated circuit according to claim 1, wherein
diodes provided in each of the diode strings include:
wells;
first high-concentration impurity diffusion layers formed on the wells;
second high-concentration impurity diffusion layers formed on the wells, arranged in parallel to the first and second power supply wires, and having a conduction type same as that of the first high-concentration impurity diffusion layers;
third high-concentration impurity diffusion layers formed on the wells, arranged between the first high-concentration impurity diffusion layers and the second high-concentration impurity diffusion layers, and having a conduction type different from that of the first high-concentration impurity diffusion layers, and
the wells on which the first, second, and third high-concentration impurity diffusion layers are formed are repeatedly arranged in a direction orthogonal to the first and second power supply wires to be adjacent to one another to form the diode string.

8. The semiconductor integrated circuit according to claim 1, wherein
the input and output cells include:
input buffers that input signals, which are applied to the input and output pads, to the internal circuit; and
output buffers that output a signal, which is output from the internal circuit, to an outside via the input and output pads.

9. The semiconductor integrated circuit according to claim 1, wherein the first electrostatic protection elements include:
first diodes, anodes of which are connected to the input and output pads and cathodes of which are connected to the first power supply wire; and
second diodes, anodes of which are connected to the second power supply wire and cathodes of which are connected to the input and output pads.

10. The semiconductor integrated circuit according to claim 9 further comprising a power supply cell including third electrostatic protection element that protect the internal circuit from electrostatic discharge between the first power supply wire and the second power supply wire.

11. The semiconductor integrated circuit according to claim 10, wherein the first electrostatic protection element comprises third diode connected between the first power supply wire and the second power supply wire such that a forward direction of the connection is a direction from a low potential side to a high potential side.

12. The semiconductor integrated circuit according to claim 11, wherein the first and second power supply wires are drawn around in the peripheral section of the semiconductor chip to cross the power supply cells, the input and output cells, and the power supply protection elements.

13. The semiconductor integrated circuit according to claim 1, wherein the input and output pads are arranged in zigzag.

14. A semiconductor integrated circuit comprising:
a first power supply pad arranged in a peripheral section of a semiconductor chip;
a second power supply pad arranged in the peripheral section of the semiconductor chip;
a first power supply wire connected to the first power supply pad;
a second power supply wire connected to the second power supply pad;
an internal circuit formed on the semiconductor chip, power being supplied thereto via the first power supply wire and the second power supply wire;
input and output pads that exchange an input signal or an output signal with the internal circuit;
input and output cells including first electrostatic protection elements that protect the internal circuit from electrostatic discharge between the input and output pads and the first or second power supply wire; and
second power supply protection elements provided in the input and output cells to be arranged between the first power supply wire and the second power supply wire and including diode strings connected between the first power supply wire and the second power supply wire.

15. The semiconductor integrated circuit according to claim 14, wherein a number of diodes of each of the diode strings is set to be within a specification of standby leak between the first power supply wire and the second power supply wire.

16. The semiconductor integrated circuit according to claim 15, wherein the diode strings are respectively provided for the input and output cells.

17. The semiconductor integrated circuit according to claim 14, wherein
diodes provided in each of the diode strings include:
wells;
first high-concentration impurity diffusion layers formed on the wells; and
second high-concentration impurity diffusion layers formed on the wells, arranged in a direction orthogonal to the first and second power supply wires to be adjacent to the first high-concentration impurity diffusion layers, and having a conduction type different from that of the first high-concentration impurity diffusion layers, and
the wells on which the first and second high-concentration impurity diffusion layers are formed are repeatedly arranged in a direction orthogonal to the first and second power supply wires to be adjacent to one another to form the diode string.

18. A semiconductor integrated circuit comprising:
a first power supply pad arranged in a peripheral section of a semiconductor chip;
a second power supply pad arranged in the peripheral section of the semiconductor chip;
a first power supply wire connected to the first power supply pad;
a second power supply wire connected to the second power supply pad;
an internal circuit formed on the semiconductor chip, power being supplied thereto via the first power supply wire and the second power supply wire;
first and second input and output pads that exchange an input signal or an output signal with the internal circuit;
a first diode string connected between the first power supply wire and the second power supply wire such that a forward direction of the connection is a direction from a high potential side to a low potential side, the first diode string forming a discharge path for a surge current input to the first input and output pad; and
a second diode string connected between the first power supply wire and the second power supply wire such that a forward direction of the connection is a direction from a high potential side to a low potential side, the second diode string forming a discharge path for a surge current input to the second input and output pad.

19. The semiconductor integrated circuit according to claim 18, wherein
the discharge path formed by the first diode string for the surge current input to the first input and output pad is shorter than a discharge path formed by the second diode string for the surge current input to the first input and output pad, and
the discharge path formed by the second diode string for the surge current input to the second input and output pad is shorter than a discharge path formed by the first diode string for the surge current input to the second input and output pad.

20. The semiconductor integrated circuit according to claim 19, wherein, when an electric current is input to the first or second input and output pad, the first and second diode strings cooperatively operate during discharge.
